(19) United States
(12) Patent Application Publication
(10) Pub. No.: US 2015/0108076 A1
(43) Pub. Date: Apr. 23, 2015

(54) TEST TUBE RACK INSERT DEVICE

(71) Applicant: Health Diagnostic Laboratory, Inc., Richmond, VA (US)

(72) Inventors: Jason BRANCH, Richmond, VA (US); Ali SAFAVI, Chester, VA (US)

(21) Appl. No.: 14/519,568

(22) Filed: Oct. 21, 2014

Related U.S. Application Data
(60) Provisional application No. 61/893,452, filed on Oct. 21, 2013.

(51) Int. Cl. B01L 9/06

(52) U.S. Cl. CPC B01L 9/06; B01L 2200/023; B01L 2200/028
USPC 211/85.18; 422/562

(57) ABSTRACT

A test tube rack insert device includes a base configured to be inserted into a test tube receiving chamber in a test tube rack. A semi-cylindrical test tube support member is coupled to the base at an edge of the base. The test tube support member extends perpendicularly from the base. The test tube support member is coupled to the base such that an angle between the base and the test tube support member is decreased by an exertion of force on an outer surface of the test tube support member to securely engage a test tube inserted into the test tube receiving chamber. A test tube rack configured to house test tubes of varying size using the test tube insert device and a method of housing test tubes of varying size using the test tube insert devices are also disclosed.

This application claims the benefit of U.S. Provisional Patent Application Ser. No. 61/893,452 filed Oct. 21, 2013, which is herein incorporated by reference.

### FIELD

The invention is related to the field of test tube storage and handling. More specifically, the present invention is directed to a test tube rack insert device, a test tube rack configured to house test tubes of varying size using the test tube rack insert device, and a method of housing test tubes of varying size using the test tube rack insert device.

### BACKGROUND

Clinical laboratories, as well as other laboratories that provide sample analysis, handle and store large numbers of samples held in test tubes. Further, the test tubes pass through various different stations within the laboratory that require the safe handling and storage of the test tubes. Various test tube racks, which include receiving chambers to receive and hold the test tubes, are utilized throughout the laboratory setting for safely storing the test tubes. The receiving chambers must be appropriately sized to ensure a snug fit with the test tube rack to avoid damage to the inserted test tubes.

Individual test tubes, however, come in a variety of different shapes and sizes. Thus, a single test tube rack may not have appropriately sized receiving chambers for ensuring a good fit for the different sized test tubes for safely storing the different sizes of tubes. Multiple racks for the different sizes may be utilized, but consume additional valuable space within the laboratory.

Various test tube rack inserts are available to insert into a receiving chamber of a test tube rack to vary the size of the receiving chamber to safely accommodate a different sized tube. Such inserts are generally complex in design and expensive to manufacture. Further, such inserts generally only accommodate a single sized test tube smaller than the diameter of the receiving chamber into which the test tube is inserted. These inserts are not adjustable to accommodate various sizes of test tubes with diameters smaller than the receiving chamber.

The present invention is directed to overcoming these and other deficiencies in the art.

### SUMMARY

One aspect of the present invention relates to a test tube rack insert device including a base configured to be inserted into a test tube receiving chamber in a test tube rack. A semi-cylindrical test tube support member is coupled to the base at an edge of the base. The test tube support member extends perpendicularly from the base. The test tube support member is coupled to the base such that an angle between the base and the test tube support member is decreased by an exertion of force on an outer surface of the test tube support member to securely engage a test tube inserted into the test tube receiving chamber.

Another aspect of the present invention relates to a test tube rack configured to house test tubes of varying size in a plurality of test tube receiving chambers. The test tube rack includes one or more test tube insert devices. The one or more test tube insert devices include a base configured to be inserted into one of the plurality of test tube receiving chambers in the test tube rack. A semi-cylindrical test tube support member is coupled to the base at an edge of the base. The test tube support member extends perpendicularly from the base. The test tube support member is coupled to the base such that an angle between the base and the test tube support member is decreased by an exertion of force on an outer surface of the test tube support member to securely engage a test tube inserted into the test tube receiving chamber.

A further aspect of the present invention relates to a method of housing test tubes of varying size comprising configuring a test tube rack with one or more test tube insert devices. The test tube insert devices include a base configured to be inserted into a test tube receiving chamber in the test tube rack. A semi-cylindrical test tube support member is coupled to the base at an edge of the base. The test tube support member extends perpendicularly from the base. The test tube support member is coupled to the base such that an angle between the base and the test tube support member is decreased by an exertion of force on an outer surface of the test tube support member to securely engage a test tube inserted into the test tube receiving chamber. In this embodiment, multiple test tubes are in the test tube rack. At least two of the test tubes are a different size.

The present invention provides an improved test tube rack insert with a design that requires less material than typical test tube rack insert designs, may be easily machined, and therefore may be economically produced. The present invention further provides a test tube rack insert device that permits insertion of various different sized test tubes. The test tube rack insert device securely holds an inserted test tube to provide safe storage within the test tube rack, regardless of the size of the test tube.

### BRIEF DESCRIPTION OF THE DRAWINGS

FIGS. 1A and 1B are side perspective views of an embodiment of the test tube rack insert device of the present invention.

FIG. 2 is a top view of the test tube rack insert device shown in FIG. 1.

FIG. 3 is a back view of the test tube rack insert device shown in FIG. 1.

FIG. 4 is a front view of the test tube rack insert device shown in FIG. 1.

FIG. 5 is a side view of the test tube rack insert device shown in FIG. 1.

FIG. 6 is a perspective view of another embodiment of the test tube rack insert device of the present invention.

FIG. 7 is a perspective view of a test tube rack including receiving chambers configured to receive the test tube rack insert device of the present invention.

FIG. 8 is a phantom view of the inside of one of the receiving chambers in the test tube rack shown in FIG. 7.

FIG. 9 is a phantom view of a receiving chamber of the test tube rack of FIG. 8 with the test tube rack insert device of FIGS. 1-5 inserted therein.

FIG. 10 is a phantom view of the receiving chamber of FIG. 9 with a test tube inserted into the test tube rack insert device.

FIG. 11 is a phantom view of a receiving chamber of the test tube rack of FIG. 8 with the test tube rack insert device of FIG. 6 inserted therein.

FIG. 12 is a phantom view of the receiving chamber of FIG. 11 with a test tube inserted into the test tube rack insert device.

### DETAILED DESCRIPTION

The present invention relates to a test tube rack insert device, a test tube rack configured to house test tubes of varying size using the test tube rack insert device, and a method of housing test tubes of varying size using the test tube rack insert device.

One aspect of the present invention relates to a test tube rack insert device including a base configured to be inserted into a test tube receiving chamber in a test tube rack. A semi-cylindrical test tube support member is coupled to the base at an edge of the base. The test tube support member extends perpendicularly from the base. The test tube support member is coupled to the base such that an angle between the base and the test tube support member is decreased by an exertion of force on an outer surface of the test tube support member to securely engage a test tube inserted into the test tube receiving chamber.

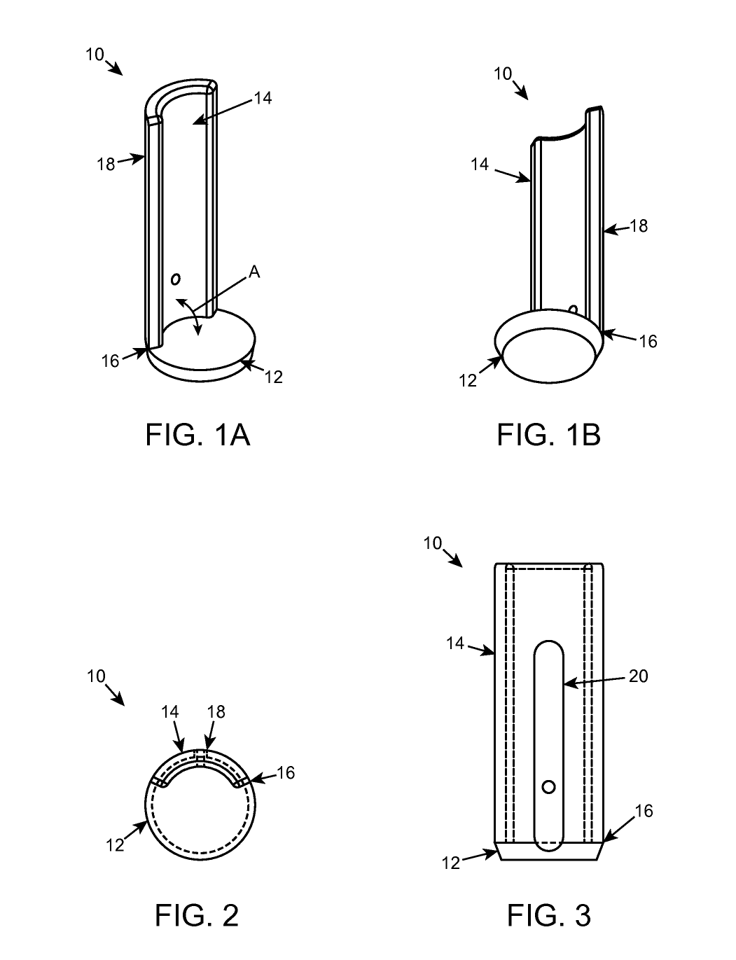

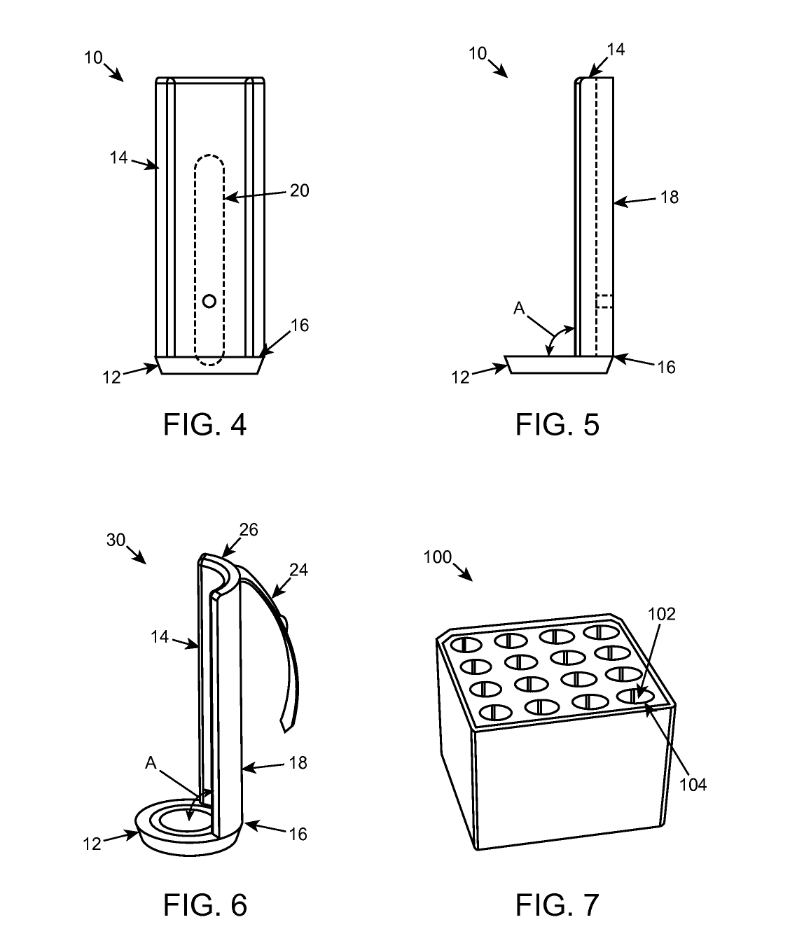

FIGS. 1-5 show perspective, top, back, front, and side views of one embodiment of a test tube rack insert device 10 of the present invention. Test tube rack insert device 10 may be inserted into a receiving chamber configured to hold a test tube in a test tube rack. The test tube rack insert device 10 is configured to receive, and securely hold, various different sizes of test tubes with a diameter smaller than the opening of the receiving chamber.

Referring again to FIGS. 1-5, test tube rack insert device 10 includes a base 12 coupled to a semi-cylindrical test tube support member 14, although the test tube rack insert device 10 may include other elements in other configurations. Base 12 is a circular support structure configured to be inserted into a test tube receiving chamber in a test tube rack, although base 12 may have other configurations. Base 12 has a diameter smaller than the diameter of the receiving chamber, and may be sized to fit different sized receiving chambers for different test tube racks. In one embodiment, base 12 is constructed of a rigid plastic such as polyoxymethylene, although other materials, such as polyethylene, polystyrene, polyamides, copolymers thereof, other thermoplastics, or metals (e.g., aluminum, tin, iron, copper, nickel, zinc, and amalgams and combinations thereof), by way of example only, may be utilized.

Semi-cylindrical test tube support member 14 is coupled to base 12 at an edge 16 of base 12. Semi-cylindrical test tube support member 14 extends perpendicular from base 12 in a semi-circle. The length of semi-cylindrical test tube support member 14 above base 12 is configured securely hold a test tube inserted into test tube insert device 10. The upper surface of test tube support member 14 that is opposite base 14 includes rounded edges at the top and sides to facilitate insertion of a test tube into test rack insert device 10, although test tube support member 14 may have other configurations suitable for insertion of a test tube. In one embodiment, semi-cylindrical test tube support member 14 is formed as less than a 180 degree semi-cylinder about edge 16 of base 12, such that semi-cylindrical test tube support member 14, such that an angle (A) between semi-cylindrical test tube support member 14 and base 12, as illustrated in FIGS. 1A and 5, may be decreased by a force exerted on an outer surface 18 of semi-cylindrical support member 14. In another embodiment, semi-cylindrical test tube support member 14 is formed as at least a 90 degree semi-cylinder about edge 16 of base 12. In one embodiment, semi-cylindrical test tube support member 14 is constructed as a rigid plastic material, such as such as polyoxymethylene, although other materials, such as polyethylene, polystyrene, polyamides, copolymers thereof, other thermoplastics, or metals (e.g., aluminum, tin, iron, copper, nickel, zinc, and amalgams and combinations thereof), by way of example only, may be utilized.

Referring more specifically to FIG. 3, in one embodiment test tube insert device 10 includes a groove 20 located in, and extending partially along the length of, outer surface 18. Groove 20 provides an interlocking interface with the receiving chamber when test tube insert device is inserted therein as discussed further below. Groove 20 is configured to match a protrusion from the inner surface of the receiving chamber of a test tube rack to provide the interlocking interface and may be designed based on the test tube rack with which the test tube insert device 10 is to be utilized. In one embodiment, test tube insert device 10 also includes a hole 22 extending through outer surface 18 of semi-cylindrical test tube support member 14. Hole 22 is configured to allow insertion of a tool for the removal of test tube insert device 10 from a receiving chamber in a test tube rack, although test tube insert device 10 may include other elements in other configurations to facilitate the removal of test tube insert device 10 from the receiving chamber.

FIG. 6 shows a perspective view of another one embodiment of a test tube insert device 30. Test tube insert device 30 is the same in structure as test tube insert device 10 except as described below. Like elements are labeled with like reference numerals. Test tube insert device 30 further includes a flexible member 24 located and extending outwardly from outer surface 18. Flexible member 24 is located at an upper edge 26 of outer surface 18, although flexible member 24 may be located at other locations on outer surface 18. Flexible member 24 is configured to contact an inner surface of a receiving chamber of a test tube rack into which test tube insert device 30 is inserted. Flexible member 24 provides an exertion of force on outer surface 18 of semi-cylindrical test tube support member 14 that alters angle (A) between semi-cylindrical test tube support member 14 and base 12. In one embodiment, flexible member 24 is a cantilever spring mechanism, although other spring mechanisms, such as a helical spring by way of example only, may be utilized. Flexible member 24 may also be a deflective apparatus or a deformative apparatus capable of providing a force on outer surface 18.

Another aspect of the present invention relates to a test tube rack configured to house test tubes of varying size in a plurality of test tube receiving chambers. The test tube rack includes one or more test tube insert devices. The one or more test tube insert devices include a base configured to be inserted into one of the plurality of test tube receiving chambers in the test tube rack. A semi-cylindrical test tube support member is coupled to the base at an edge of the base. The test tube support member extends perpendicularly from the base. The test tube support member is coupled to the base such that an angle between the base and the test tube support member is decreased by an exertion of force on an outer surface of the test tube support member to securely engage a test tube inserted into the test tube receiving chamber.

FIG. 7 shows a perspective view of a test tube rack 100 of the present invention. Test tube rack 100 is configured to house test tubes of varying size utilizing test tube rack insert device 10. Test tube rack 100 includes a plurality of test tube receiving chambers 102. The plurality of test tube receiving chambers 102 each include an opening 104 configured to receive a test tube. The diameter of opening 104 for each of the plurality of receiving chambers 102 determines the size of test tube that will fit inside the receiving chambers. Test tube insert device 10 may inserted into one or more of the plurality of receiving chambers 102 to provide secure engagement of a test tube with a smaller diameter than opening 104 within the one or more of the plurality of receiving chambers 102 housing test tube insert device 10.

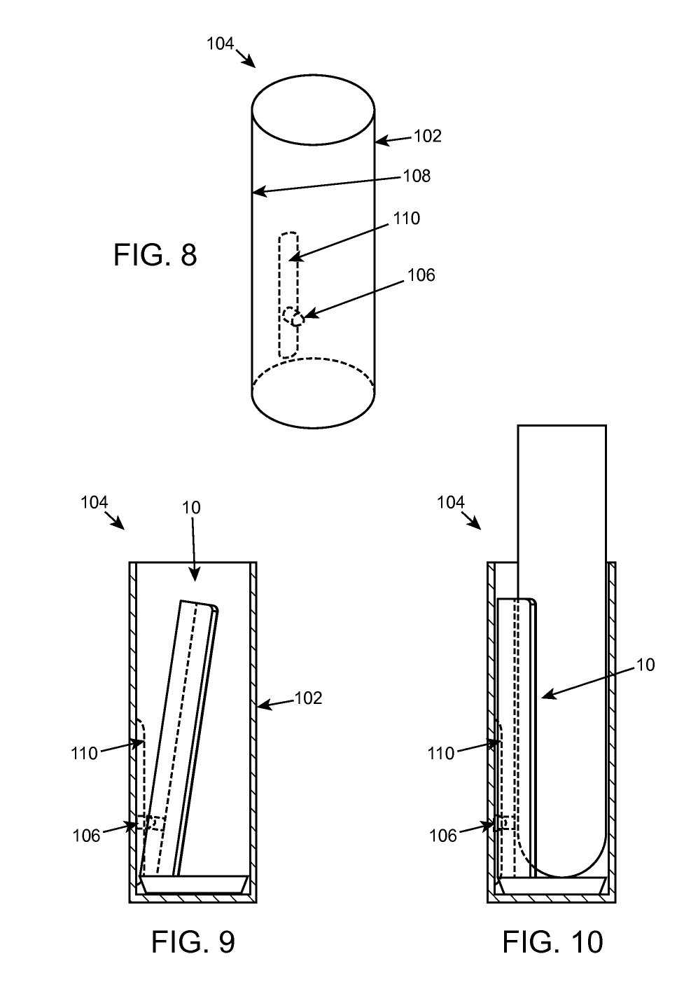

Referring now to FIG. 8, which shows one receiving chamber 102 of test tube rack 100, receiving chamber 102 optionally includes a spring-loaded protrusion 106 on an inner surface 108 of each of the plurality of test tube receiving chambers 102. Test tube insert device 10 may be inserted into the receiving chamber 102 such that outer surface 18 of test tube support member 14 faces spring-loaded protrusion 106 to provide a force on outer surface 18 of test tube support member 14. In one embodiment, test tube rack 100 further includes a protrusion 110 on inner surface 106 configured to match groove 20 such that protrusion 110 mates with groove 20 when test tube insert device 10 is inserted into receiving chamber 102 to provide an interlocking interface between receiving chamber 102 and test tube insert device 10.

A further aspect of the present invention relates to a method of housing test tubes of varying size comprising configuring a test tube rack with one or more test tube insert devices. The test tube insert devices include a base configured to be inserted into a test tube receiving chamber in the test tube rack. A semi-cylindrical test tube support member is coupled to the base at an edge of the base. The test tube support member extends perpendicularly from the base. The test tube support member is coupled to the base such that an angle between the base and the test tube support member is decreased by an exertion of force on an outer surface of the test tube support member to securely engage a test tube inserted into the test tube receiving chamber. In this embodiment, multiple test tubes are in the test tube rack. At least two of the test tubes are a different size.

Referring now to FIG. 9, in operation, test tube insert device 10 is inserted into one of the receiving chambers 102 of test tube rack 100, although test tube insert devices may be inserted in any number of the plurality of receiving chambers in the test tube rack. Test tube rack insert device 10 is inserted such that groove 20 mates with protrusion 110 to provide an interlocking interface between test tube rack insert device 10 and receiving chamber 102. In one embodiment, outer surface 18 of test tube support member 14 is positioned to be in contact with spring-loaded protrusion 106 to provide a force on outer surface 18. The force on outer surface 18 decreases the angle (A) between test tube support member 14 and base 12.

Referring now to FIG. 10, a test tube is inserted into the receiving chamber 102. The inserted test tube has a diameter smaller than opening 104 of the receiving chamber 102. Insertion of the test tube causes test tube support member 14 to push against the force on outer surface 18 to securely engage the test tube within receiving chamber 102. The force is provided by spring-loaded protrusion 106 on inner surface 108 of receiving chamber 102. Multiple test tubes, at least two of which have a different diameter, may placed in receiving chambers 102 housing test tube insert device 10 in the test tube rack 100.

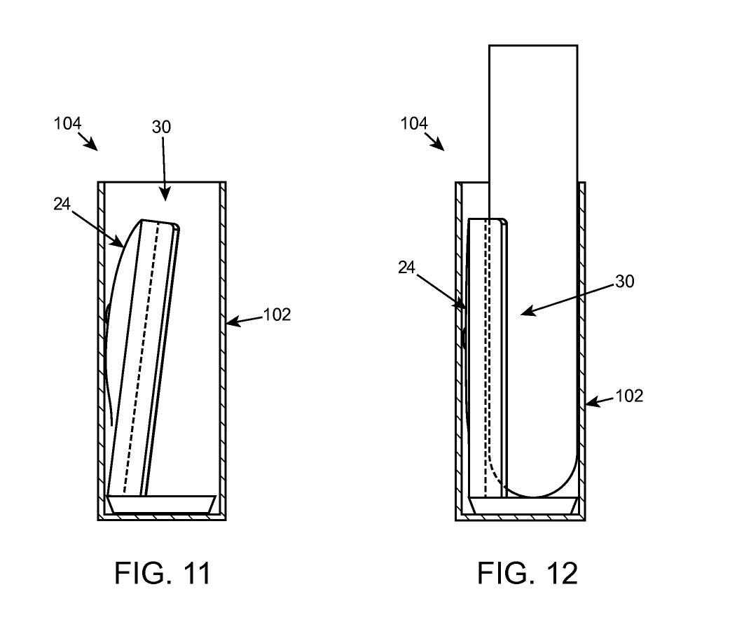

Referring now to FIG. 11, in operation, tube insert device 30, as shown in FIG. 6, is inserted into receiving chamber 102. Flexible member 24 contacts inner surface 108 of receiving chamber 102 to provide a force on outer surface 18 to decrease the angle (A) between test tube support member 14 and base 12. Referring now to FIG. 12, a test tube is inserted into the receiving chamber 102. The inserted test tube has a diameter smaller than opening 104 of the receiving chamber 102. Insertion of the test tube causes test tube support member 14 to push against the force created by flexible member 24 on outer surface 18 to securely engage the test tube within receiving chamber 102. Multiple test tubes, at least two of which have a different diameter, may be placed in receiving chambers 102 housing test tube insert device 30 in the test tube rack 100.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A test tube rack insert device comprising:
a base configured to be inserted into a test tube receiving chamber in a test tube rack;
a semi-cylindrical test tube support member coupled to the base at an edge of said base, the test tube support member extending perpendicularly from said base, wherein said test tube support member is coupled to said base such that an angle between the base and the test tube support member is decreased by an exertion of force on an outer surface of the test tube support member to securely engage a test tube inserted into the test tube receiving chamber.

2. The test tube rack insert device of claim 1, wherein the test tube support member is constructed of a rigid plastic material.

3. The test tube rack insert device of claim 1 further comprising:
a flexible member extending from the outer surface of the test tube support member and configured to contact an inner surface of the test tube receiving chamber, wherein said flexible member provides the exertion of force on the outer surface of the test tube support member to securely engage a test tube inserted into the test tube receiving chamber.

4. The test tube rack insert device of claim 3, wherein the flexible member is at least one of a spring mechanism, a deflective apparatus, or a deformative apparatus.

5. The test tube rack insert device of claim 1, wherein the test tube support member is at least 90 degrees.

6. The test tube rack insert device of claim 5, wherein the test tube support member is less than 180 degrees.

7. The test tube rack insert device of claim 1, wherein the test tube support member further comprises a groove in the outer surface of the test tube support member to provide an interlocking interface with the test tube receiving chamber when inserted therein.

8. The test tube rack insert device of claim 1, wherein the test tube support member further comprises a hole configured to allow removal the test tube rack insert device from the test tube receiving chamber.

9. The test tube rack insert device of claim 1, wherein the test tube support member securely engages a test tube inserted into the test tube receiving chamber, said test tube having a diameter smaller than a diameter of the test tube receiving chamber.

10. A test tube rack configured to house test tubes of varying size in a plurality of test tube receiving chambers, the test tube rack comprising one or more test tube insert devices, the one or more test tube insert devices comprising:
a base configured to be inserted into one of the plurality of test tube receiving chambers in the test tube rack;
a semi-cylindrical test tube support member coupled to the base at an edge of said base, the test tube support member extending perpendicularly from said base, wherein said test tube support member is coupled to said base such that an angle between the base and the test tube support member is decreased by an exertion of force on an outer surface of the test tube support member to securely engage a test tube inserted into the test tube receiving chamber.

11. The test tube rack of claim 10 further comprising:
a spring-loaded protrusion on an inner surface of the plurality of the test tube receiving chambers, wherein the spring-loaded protrusion wherein the spring-loaded protrusion provides the exertion of force on the outer surface of the test tube support member to securely engage a test tube inserted into the test tube receiving chamber.

12. The test tube rack of claim 10 wherein the one or more test tube insert devices further comprise:
a flexible member extending from the outer surface of the test tube support member and configured to contact an inner surface of the test tube receiving chamber, wherein said flexible member provides the exertion of force on the outer surface of the test tube support member to securely engage a test tube inserted into the test tube receiving chamber.

13. The test tube rack of claim 12, wherein the flexible member is at least one of a spring mechanism, a deflective apparatus, or a deformative apparatus.

14. The test tube rack of claim 10, wherein the test tube support member is at least 90 degrees.

15. The test tube rack of claim 14, wherein the test tube support member is less than 180 degrees.

16. The test tube rack of claim 10 further comprising:
a protrusion located on an inner surface of the plurality of test tube receiving chambers, the protrusion configured to mate with a groove in the outer surface of the test tube support member of the one or more insert devices to provide an interlocking interface between the test tube receiving chamber and the one or more test tube insert devices when inserted therein.

17. A method of housing test tubes of varying size, the method comprising:
configuring a test tube rack with one or more test tube insert devices, wherein the test tube insert devices comprise:
a base configured to be inserted into a test tube receiving chamber in the test tube rack;
a semi-cylindrical test tube support member coupled to the base at an edge of said base, the test tube support member extending perpendicularly from said base, wherein said test tube support member is coupled to said base such that an angle between the base and the test tube support member is decreased by an exertion of force on an outer surface of the test tube support member to securely engage a test tube inserted into the test tube receiving chamber; and
placing multiple test tubes in the test tube rack, wherein at least two of the test tubes are a different size.

18. The method of claim 17 wherein the one or more test tube insert devices further comprise:
a flexible member extending from the outer surface of the test tube support member and configured to contact an inner surface of the test tube receiving chamber, wherein said flexible member provides the exertion of force on the outer surface of the test tube support member to securely engage a test tube inserted into the test tube receiving chamber.

19. The method of claim 18, wherein the flexible member is at least one of a spring mechanism, a deflective apparatus, or a deformative apparatus.

20. The method of claim 17, wherein the test tube support member is at least 90 degrees.

21. The method of claim 20, wherein the test tube support member is less than 180 degrees.
